(19) United States
(12) Patent Application Publication
(10) Pub. No.: US 2020/0079585 A1
(43) Pub. Date: Mar. 12, 2020

(54) METHODS AND SYSTEMS FOR WASTE STORAGE CONTAINER

(71) Applicant: Adam Douglas Everard, Manitowoc, WI (US)

(72) Inventor: Adam Douglas Everard, Manitowoc, WI (US)

(21) Appl. No.: 16/563,998

(22) Filed: Sep. 9, 2019

Related U.S. Application Data
(60) Provisional application No. 62/728,906, filed on Sep. 10, 2018.

(51) Int. Cl. B65F 1/14; B65F 1/06; B65D 81/38

(52) U.S. Cl. CPC B65F 1/14; B65F 2001/1653; B65D 81/3802; B65F 1/06

(57) ABSTRACT

A storage container with a climate controlled inner chamber.

### BACKGROUND INFORMATION

### Field of the Disclosure

Examples of the present disclosure relate to systems and methods for a waste storage container. Specifically, embodiments relate to storage container with a climate controlled inner chamber.

### Background

A waste container is a container for temporarily storing waste. Conventional waste containers come and many different shapes, sizes, and materials. Waste when remaining in conventional waste containers is susceptible to bacteria growth, odors, and other undesirable outcomes. Furthermore, legislation has controlled how certain waste must be handled.

Accordingly, needs exist for system and methods for a waste storage container with a climate controlled inner chamber.

### SUMMARY

Embodiments relate to storage container with a climate controlled inner chamber. Embodiments described herein may include a base, exterior shell, insulating layer, interior shell, a lid, and a hinge.

The base may be a lower surface of the storage container, and may be configured to be positioned below the rest of the elements associated with the storage container. The base may include a flat, planar lower surface, and projections, wherein the projections extend away from the lower surface. The projections may be configured to be positioned adjacent to the outer surface of the exterior shell to hold the outer shell in place. In embodiments, a diameter across the base may be greater than that of the exterior shell.

The exterior shell may be a hollow cylindrical container with a closed lower surface, and an open upper surface. The exterior shell may be configured to be positioned above the base and within the projections of the base. In embodiments, the exterior shell may be comprised of rigid materials, such as plastics, metals, etc.

The insulating layer may be a shell that is configured to be positioned between the exterior shell and the interior shell. The insulating layer may have a thickness that is greater than both the interior layer and the exterior layer. The insulating layer may be configured to retain chilled or heated air within the storage container, and be a noise reduction lining. The insulating layer may be embedded with charcoal to reduce odors within the storage device. The insulating layer may include a closed, lower surface that is vertically offset from the closed lower surface of the exterior shell, such that elements of the storage container may be positioned between the lower surfaces of the exterior shell and the insulating layer.

The interior shell may be configured to be positioned within an inner circumference of the insulating layer. The interior shell may be comprised of materials with high thermal conductivity. The thermal conductivity of the interior shell may allow for a more even heat or cold distribution within a hollow chamber within the storage device. Furthermore, this may cause a more even distribution of heat transfer to materials positioned with the storage device. In embodiments, a lower, closed surface of the interior shell may have a first temperature plate.

The first temperature plate may be configured to be heated or chilled. For example, the first temperature plate may be a cooling plate or a hot plate. The temperature change created by the first temperature plate may be transferred through the sidewalls of the interior shell from the lower surface of the interior shell to the rim of the interior shell. In implementations, heat transfer plates may be positioned less than six inches, but no more than twelve inches from the bag.

The lid may be configured to be coupled to the exterior shell via the hinge. The lid may be configured to be rotated between an open position and a closed position. In the open position, an open, upper surface of the hollow chamber may be exposed to the environment. In the closed position, the open, upper surface the open, upper surface of the hollow chamber may be sealed. The lid may include a second temperature plate that is configured to be heated or chilled. For example, the second temperature plate may be a cooling plate or a hot plate. The temperature change created by the second temperature plate may be transferred into the hollow chamber through convection and conduction. The second temperature plate may be configured to be positioned away from an upper surface of the interior shell.

In embodiments, the first temperature plate and the second temperature plate may be the same temperature, or the first temperature plate and the second temperature plate may be independently controlled to be different temperatures. In embodiments, the first temperature plate and/or the second temperature plate may be configured to transfer heat via thermoelectric heat transfer, which may be quitter than that of a vacuum pump system.

The hinge may be configured to couple the lid and the exterior shell together, such that the lid may be positioned away from or adjacent to the exterior shell. This may enable the first temperature plate and the second temperature plate to be in a position that is parallel to each other when the lid is in the closed position, or perpendicular to each other when in the lid is in the open position.

In further embodiments, the storage container may include wheels and a handle, which may assist in the movement of the storage container.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a storage container with climate controlled inner chamber, according to an embodiment.

FIG. 2 depicts a storage container in a closed position, according to an embodiment.

FIG. 3 depicts a method for handling materials within a climate control storage container, according to an embodiment.

FIG. 4 depicts an exploded view of a base, exterior shell, insulating layer, and interior shell.

FIG. 5 depicts an exploded view of a lid, according to an embodiment.

FIG. 6 depicts elements of a storage container, according to an embodiment.

FIG. 7 depicts elements of a lid, according to an embodiment.

FIG. 8 depicts elements of a storage container, according to an embodiment.

FIGS. 9-16 depict various views of a storage container, according to an embodiment.

FIG. 17-23 depict various views of a storage container, according to an embodiment.

FIG. 24 depicts a storage container, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art, that the specific detail need not be employed to practice the present embodiments. In other instances, well-known materials or methods have not been described in detail in order to avoid obscuring the present embodiments.

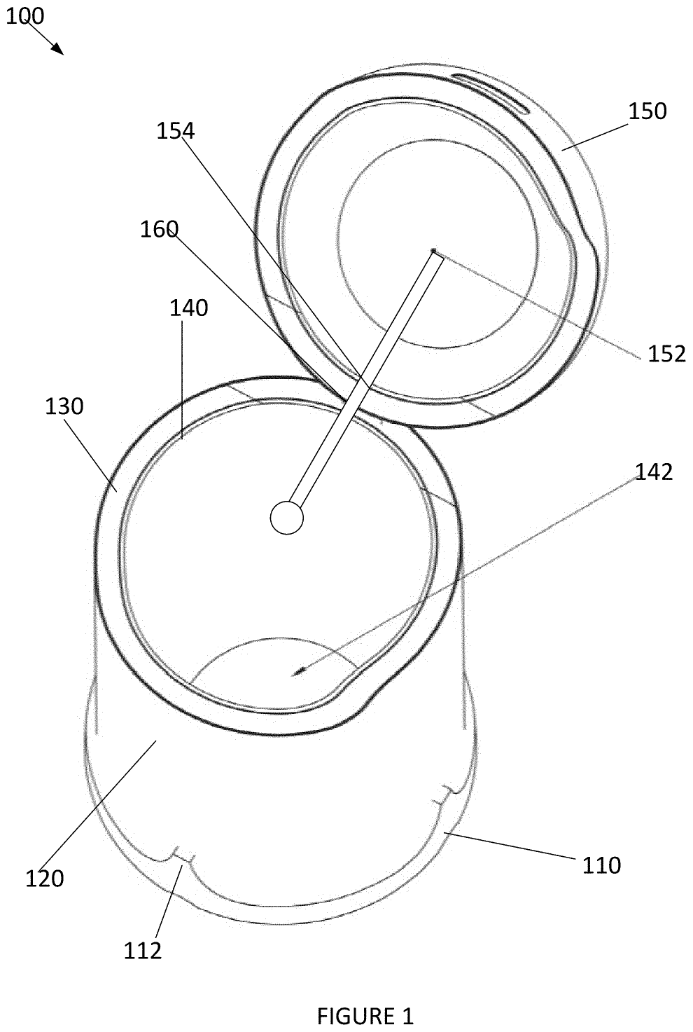

FIG. 1 depicts a storage container 100 with climate controlled inner chamber, according to an embodiment. Storage container 100 may be configured to generate heated or chilled air, and circulate the heated or chilled air within the inner chamber. This may allow for a climate controlled inner chamber that reduces, minimizes, or eliminates bacteria and odor from being formed within the inner chamber. Storage container 100 may include a base 110, exterior shell 120, insulating layer 130, interior shell 140, lid 150, and hinge 160.

Base 110 may be a lower surface of storage container 100, and may be configured to be positioned the rest of the element associated with storage container 100. Base 110 may include a flat, planer lower surface, and projections 112. Projections 112 may extend away from the lower surface, and may be configured to be positioned adjacent to the outer surface of exterior shell 120. This may enable projections 112 to secure exterior shell in place. A diameter across base 110 may be greater than that across exterior shell 120.

Exterior shell 120 may be a hollow cylindrical container with a closed, lower surface, and an open upper surface. Exterior shell 120 may be configured to be positioned above base 110 and within projections 112. In embodiments, exterior shell 120 may be comprised of rigid materials, such as plastics, metals, etc.

Insulating layer 130 may be a shell, layer, casing, etc. that is positioned between exterior shell 120 and interior shell 140. Insulating layer may have a thickness that is greater than both interior shell 140 and exterior shell 120. Insulating layer 130 may be comprised of an inert material, and to be a noise reduction lining. Insulating layer 130 may be embedded with charcoal, which may assist in reducing odors within storage device 100. There may be a cavity between the lower, planer surface of exterior shell 120 and insulating layer 130. In embodiments, a power supply and other electronics may be positioned within the cavity. This may allow a venting of air below the other elements of storage container 100. In embodiments, insulating layer 130 may be comprised of materials that is configured to reduce, limit, minimize, etc. heat transfer, vibrations, odor, etc. outside of the interior shell 140.

Interior shell 140 may be configured to be positioned within an inner circumference of insulating layer 140. Interior shell 140 may be comprised of materials with high thermal connectivity, which may be of a black or dark color. This may allow for more uniform heat transfer throughout the sidewalls of interior shell 140 to a bag 170, wherein the bag is positioned adjacent to the inner sidewalls of interior shell 140 to allow heat transfer via conduction and convection. In further embodiments, a lower surface of interior shell 140 may include a mesh, which allows ventilation out of the inner shell 140 into an area outside of storage container 100.

A lower closed, surface of interior shell 140 may include a first temperature plate 142, which may be positioned on an opposite side of storage container 100 than lid 150. In embodiments, interior shell 140 may be a dark color as compared to conventional refrigerators. This may limit the light level inside of the storage container 100. In embodiments, the inner surface of interior shell 140 may include mirrors. The bag 170 may be configured to be positioned within interior shell 140, wherein the bag 170 may extend from a distal end of interior shell to a rim of interior shell 140. This may maximum the conduction of cooled air from the interior shell 140 to the bag 170, enabling a more uniform transfer of heat to the bag and the elements within the bag 170.

First temperature plate 142 may be a device that is configured to increase or decrease in temperature. In embodiments, first temperature plate 142 may have a circumference that occupies the entire closed, lower surface of interior shell 140. This may enable the sidewalls of interior shell to be contacting the circumference of first temperature plate 142. Responsive to first temperature plate 142 changing its temperature, the temperature within the hollow chamber in storage container 100 may also dynamically change based on convection and conduction.

In implementations, a removable bag, liner, etc. may be configured to be positioned within interior shell 140 and cover an upper edge of interior shell 140. This may allow for materials positioned within the removable bag to not directly contact the inner sidewalls of interior shell 140. The removable bag may be configured to touch all four sides of the interior shell 140, and cover at least sixty percent of the closed, lower surface of the interior shell 140. In implementations, the removable bag may contact eighty percent of the closed, lower surface, eighty percent of the sidewalls, and twenty percent of the rim of interior shell. This may allow for easier heat transfer to the removable bag through conduction. More specifically there may be less than half an inch of space between the removable bag and the inter shell's 140 sidewalls or closed lower surface. However, the fans and/or the second temperature plate 152 may not directly contact the removable bag.

Lid 150 may be a device that is coupled with exterior shell 120 via hinge 160. Lid 150 may be configured to rotate between an open position, wherein the hollow chamber within storage container 100 is exposed, and a closed position, wherein the hollow chamber with storage container 100 is sealed. In the closed position, a rim of lid 150 may be positioned adjacent to the upper circumferences of exterior shell 120, insulating layer 130, and interior shell 140. In embodiments, an inner surface of lid 150 may include ultra violate lights, wherein the ultraviolet lights may be configured to emit light into the hollow chamber within the hollow chamber. The ultraviolet lights may be manually control or set with automatic timing cycles with varying frequency, alteration, cadence, etc. Lid 150 may include a second temperature plate 152 and stirring rod 154.

Second temperature plate 152 may be a device that is configured to increase or decrease in temperature. In embodiments, second temperature plate 152 may be embedded within lid 150, such that second temperature plate 152 is vertically offset from a contact point between lid 150 and exterior shell 120, insulating layer 130, and interior shell 140. Second temperature plate 152 may have a diameter that is smaller than first temperature plate 142. The temperature change created by second temperature plate may be transferred into the hollow chamber through convection and conduction. In embodiments, a temperature associated with first temperature plate 142 may be the same or different from a temperature associated with second temperature plate 152. This may allow for a temperature associated with either plate to be independently controlled, initiated, and/or turned off. In embodiments, first temperature plate 142 and second temperature plate 152 may be configured to operate on cycles. This may enable the hollow chamber within storage container 100 to have a variable temperature, which may inhibit the growth of bacteria within the chamber. In embodiments, first temperature plate 142 and/or second temperature plate 152 may also be configured to emit UV light. The UV light may be emitted on user controlled cycles to limit, reduce, restrict, etc. bacteria growth within the storage container 100. By positioning UV light emitting sources on both ends of the storage container 100 more surface area within the storage container 100 may receive UV light.

Stirring rod 154 may be a shaft, tube, etc. with a first end that is configured to be coupled with an inner surface of lid 152, and a second end that is configured to be removable inserted within the hollow chamber in storage container 100. The second end may include a projection, protrusion, etc. that is configured to interact with materials positioned within the hollow chamber. In implementations, stirring rod 154 may be configured to rotate three hundred sixty degrees while lid 150 is in the open or closed position. Responsive to stirring rod 154 being rotated, the second end of stirring rod 152 may interact with the material within the hollow chamber to move the material within the hollow chamber. This may allow materials within the hollow chamber to more evenly receive heat generated by first temperature plate 142, second temperature plate 152, and/or through conduction by repositioning materials against the sidewalls of interior shell 140.

Hinge 160 may be a device that is configured to couple exterior shell 110 and lid 150 together. Further, hinge 160 may be configured to allow lid 150 to rotate between the open position and the second position. Responsive to lid 150 rotating from the closed position to the open position, second temperature plate 152 may move from a first plane that is perpendicular to a central axis of storage container 100 to a second plane that is in parallel to the central axis of storage container 100.

In further implementations, fans may be positioned on the bottom surface of insulating layer 130, wherein interior shell 140, exterior shell 120, and insulating layer 130 may have holes, vents, etc. that enable the fans to pull the air from a hollow chamber within interior shell 140 through the vents, and into an area outside of exterior shell. By positioning the fans on the bottom surface of insulating layer 130 responsive to opening lid 150 all of the air within the hollow chamber from lid 150 to the bottom of interior shell 140 may be pulled through the hollow chamber, and exit the storage container 100. This may require a full chamber of air within the storage container 100 to be cycled and vacuumed.

A first fan positioned on insulating layer 130 may be configured to move air towards lid 150 when storage container 100 is in a closed position, and a second fan position on lid 150 may be configured to move air towards the closed lower surface of insulating layer 130 when storage container 100 is in the closed position. In other embodiments, the fans may be configured to operate as a vacuum to remove air from the hollow chamber, control a pressure level within the hollow chamber, and reposition the air outside of the hollow chamber. This may limit the amount of bacteria that enters or is positioned within the hollow chamber. Further, the vacuum may extract air from storage container 100 to help with cooling the hollow chamber and minimize a volume of the hollow chamber to increase the pressure within the hollow chamber. The fans may be independently controlled, such that a rotation speed of the fans may be different or the same. Further, a rotational direction of the first fan and second fan may be the same and/or different. This may assist in having more uniform convection within the hollow chamber. In implementations, the fans may be positioned less than six inches, but no more than twelve inches from the bag.

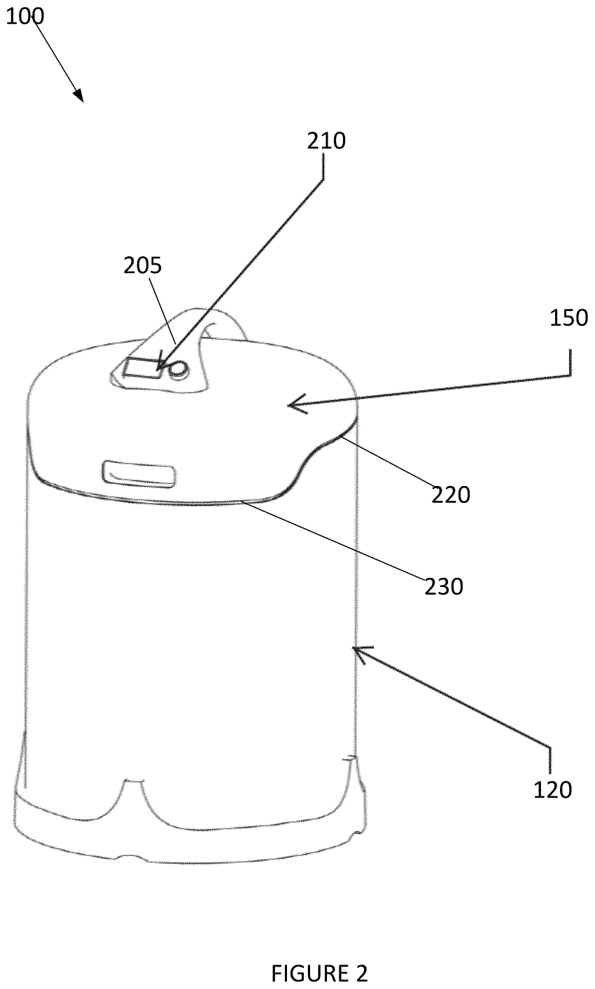

FIG. 2 depicts storage container 100 in a closed position, according to an embodiment. Elements depicted in FIG. 2 may be described above, and for the sake of brevity another description of these elements is omitted.

As depicted in FIG. 2, lid 150 may include a handle 205 and a user interface 210. Handle 205 may be configured to assist a user in moving storage container 100 from a first location to a second location.

User interface 210 may be a digital control panel that allows a user to change a temperature associated with a first temperature plate or second temperature plate, and a rotation rate of the first fan or second fan. Furthermore, utilizing user interface 210 a user may rotate stirring rod 154 in a first direction or second direction. Utilizing the user interface 210 the user may program the first temperature plate and/or the second temperature plate to set and control a temperature within the hollow chamber. In embodiments, the temperature within the hollow chamber may be based on: a temperature outside of the hollow chamber, such as the temperature within the hollow chamber is set at a predetermined value above or below the temperature outside of the container, predetermined timing patterns, etc.

As further depicted in FIG. 2, when lid 150 is in the closed position a seal may be formed between lid 150 and exterior shell 120. The seal may include an upper seal portion 220 and a lower seal portion 230, wherein lower seal portion 230 is vertically offset from upper seal portion 220. This may allow lid 150 to be positioned within an indentation within exterior shell 120 in the close position, which may enable an upper surface of the insulating layer 130 to be in contact with a lower surface of lid 150.

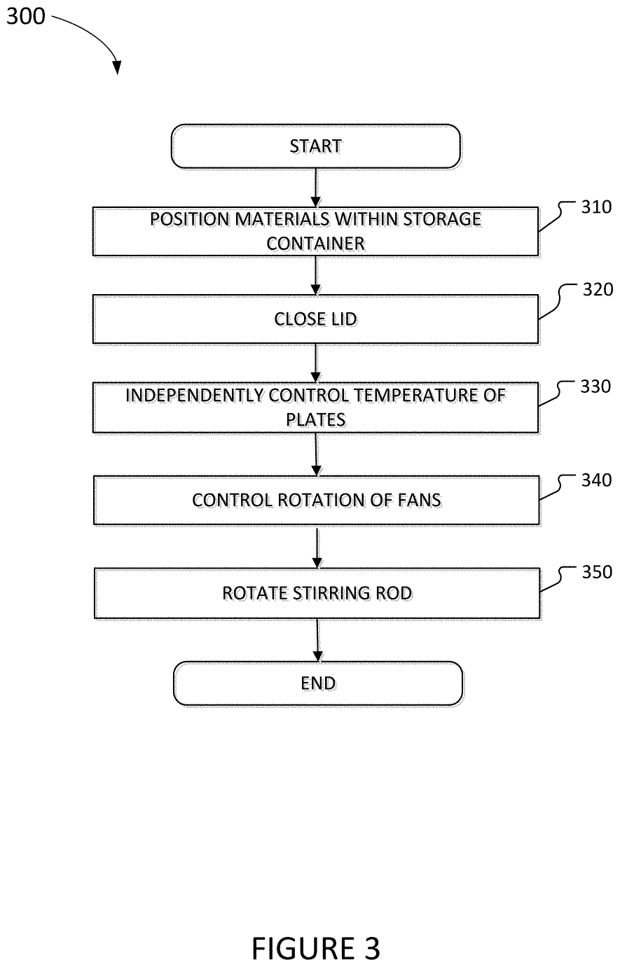

FIG. 3 depicts a method 300 for handling materials within a climate control storage container, according to an embodiment. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting. Furthermore, the operations of method 300 may be repeated for subsequent valves or zones in a well.

At operation 310, a lid of the storage container may be rotated away from an external shell, exposing a hollow chamber. Materials, such as waste, may be positioned within storage container.

At operation 320, the lid of the storage container may be rotated towards the external shell, which may seal the hollow chamber.

At operation 330, a first temperature associated with a first temperature plate may be set by a user performing actions on a user interface, wherein the first temperature plate may be positioned at a closed, bottom surface of the hollow chamber. Additionally, a second temperature associated with a second temperate plate may be set by the user performing actions on the user interface, wherein the second temperature plate may be positioned on an inner surface of the lid. Responsive to changing the temperature of the first or second temperature plate, inner sidewalls of an interior shell may transfer the heat substantially equally within the inner sidewalls. However, by varying a temperature of the first or second temperature plate, the heat distribution within the inner sidewalls may dynamically change allowing for a non-uniform climate between the proximal and distal end of the hollow chamber.

At operation 340, a first fan positioned proximate to the closed, bottom surface of the hollow chamber blowing air towards the open end of the hollow chamber may be initialized. Additionally, a second fan positioned proximate to the lower surface of the lid blowing air towards the closed, bottom surface of the hollow chamber may be initialized. This may allow for air to be circulated within the hollow chamber in multiple directions.

At operation 350, a stirring rod extending from the lid towards the closed, bottom surface of the hollow chamber may be rotated. A distal end and a shaft of the stirring road may interact with materials positioned within the hollow chamber to move the materials.

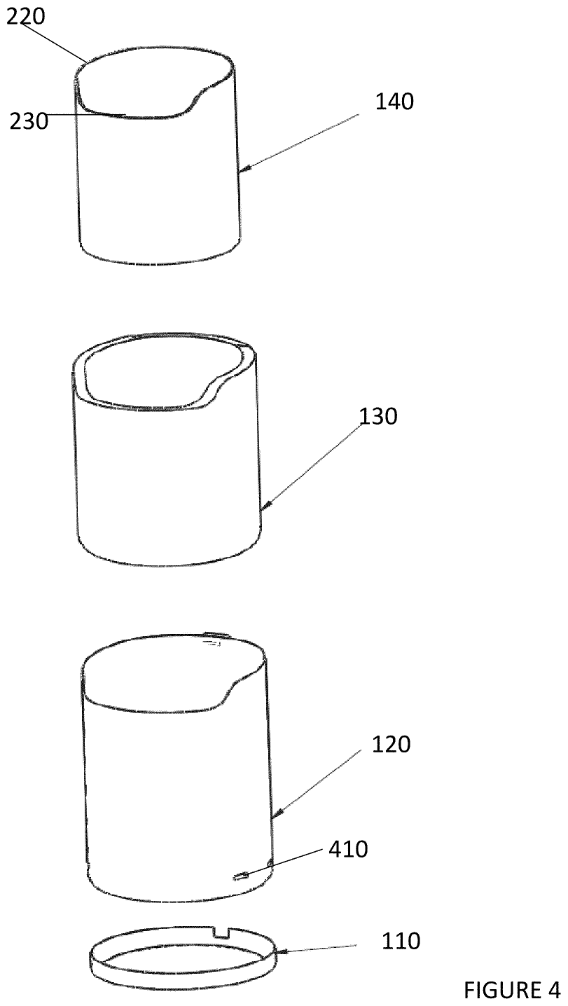

FIG. 4 depicts an exploded view of base 110, exterior shell 120, insulating layer 130, and interior shell 140. Elements depicted in FIG. 4 may be described above, and for the sake of brevity a further description of these elements may be omitted.

As depicted in FIG. 4, each of the exterior shell 120, insulating layer 130, and interior shell 140 may have a corresponding upper seal portion 220 and lower seal portion 230, wherein lower seal portion 230 is vertically offset from upper seal portion 230. This may allow a lip associated with lid 150 to extend downward into a cutout created by the lower surface of lower seal portion 230.

As further depicted in FIG. 4, exterior shell 120 may include a plurality of vents 410. Vents 410 may allow air to flow into and out of an area outside of exterior shell 120 and an area between base 110, the insulating layer, and the lower surface of exterior shell 120.

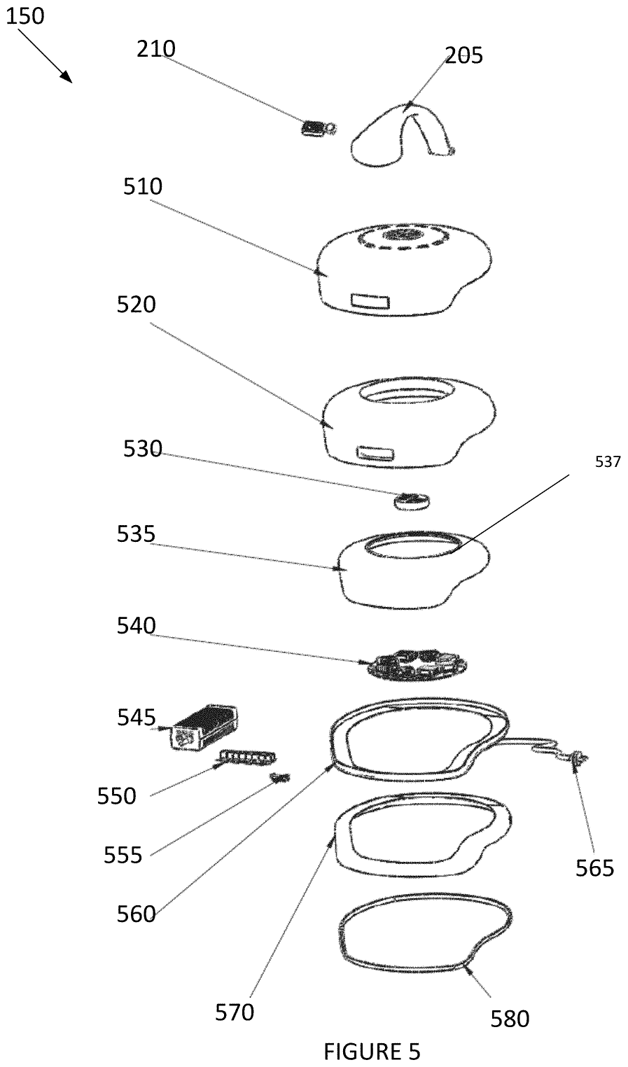

FIG. 5 depicts an exploded view of lid 150, according to an embodiment. Elements depicted in FIG. 5 may be described above, and for the sake of brevity a further description of these elements may be omitted.

As depicted in FIG. 5, lid 150 may include a lid exterior shell 510, lid insulating layer 520, and lid interior shell 535, which may correspond in thickness to that of the exterior shell 120, insulating layer 130, and interior shell 140.

Embedded within lid 150 may be cooling fan 530 that is configured to rotate. Responsive to cooling fan 530 rotation, the air within the hollow chamber may move. Furthermore, second cooling plate 540 may be configured to be positioned within an orifice 537 positioned within lid interior shell 535.

In embodiments, lid 150 may also include a fan or power supply 545, relay 550, Arduino hardware 555, a cover flange 560, base flange 570, seal 580. An electrical cord and plug 565 may be configured to be electrically connected to power supply 545 to supply power to elements within storage container 100.

In embodiments, seal 580 may be embedded within a lower surface of base flange 570, such that seal 580 is not exposed to an area outside of lid 150 if lid 150 is in the closed position. In embodiments, an insert, bag, container, etc. may be configured to be positioned between base flange 570 and cover flange 560. This may enable the bag to be secured in place, and not exposed, while lid 150 is in a closed position, while also enable an upper portion of the bag to be secured against a rim of base flange 570. This may enable more of the bag to contact the inner sidewalls of interior shell 140.

In embodiments, power plug 565 may be positioned on lid 150, such that the plug may rotate away from the hollow chamber within storage container 100.

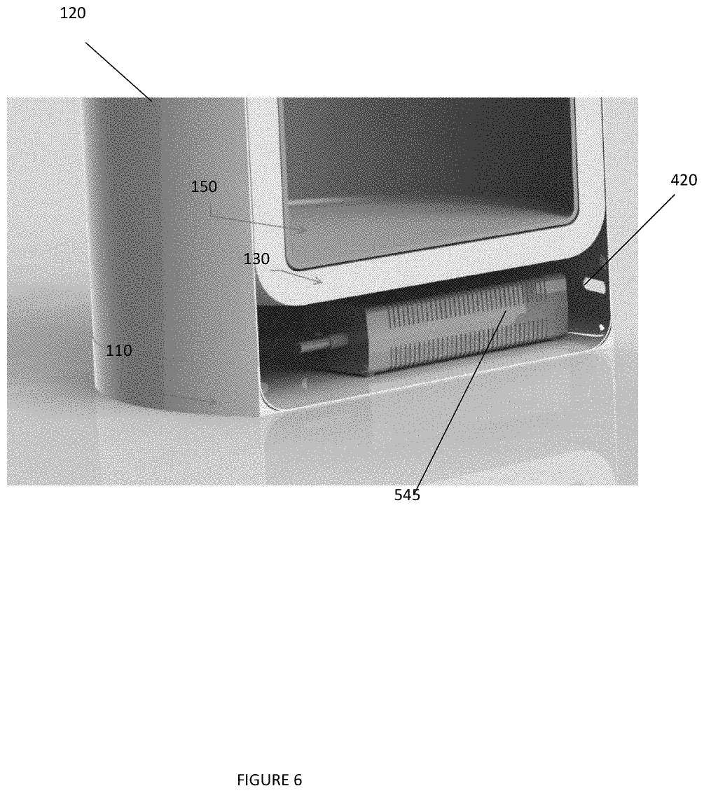

FIG. 6 depicts elements of storage container 100, according to an embodiment. Elements depicted in FIG. 6 may be described above, and for the sake of brevity a further description of these elements may be omitted.

As depicted in FIG. 6, a power supply 545 may be positioned within a space between exterior shell 120 and insulating layer 130, wherein vents 420 are positioned through a sidewall of exterior shell 120. As further depicted in FIG. 6, a lower surface of insulating layer 130 may be offset from a lower surface of exterior shell 120 to form the cavity where power supply 545 may be positioned.

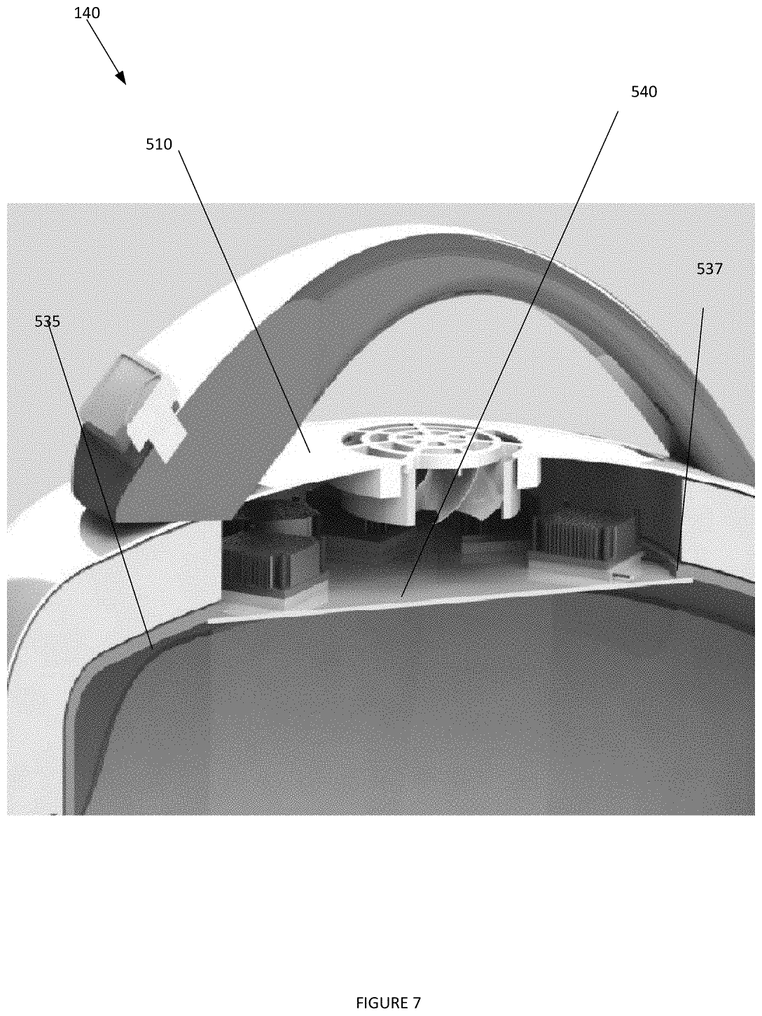

FIG. 7 depicts elements of lid 150, according to an embodiment. Elements depicted in FIG. 7 may be described above, and for the sake of brevity a further description of these elements may be omitted.

As depicted in FIG. 7, second temperature plate 540 may be positioned on an inner surface of lid interior shell 535 to cover orifice 537. Furthermore, a cavity may be formed between an exterior surface of second temperature plate 540 and lid exterior shell 510 within lid 150. This may enable the second temperature plate 540 to be positioned away from an opening of interior shell 140 even if lid 150 is in the closed position.

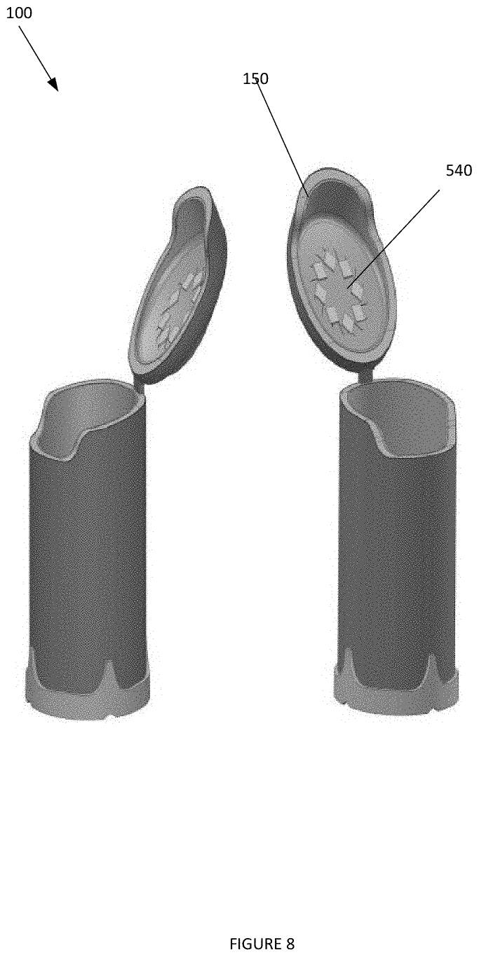

FIG. 8 depicts elements of storage container 100, according to an embodiment. Elements depicted in FIG. 8 may be described above, and for the sake of brevity a further description of these elements may be omitted.

As depicted in FIG. 8, second temperature plate 540 may be positioned on an inner surface of lid 150. This may enable second temperature plate 540 to be rotated away from a central axis of the hollow chamber.

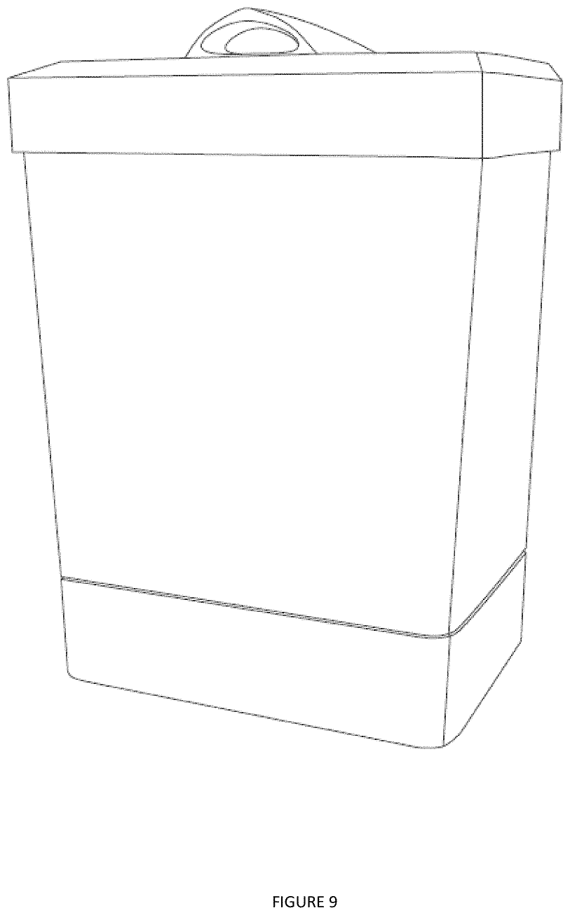

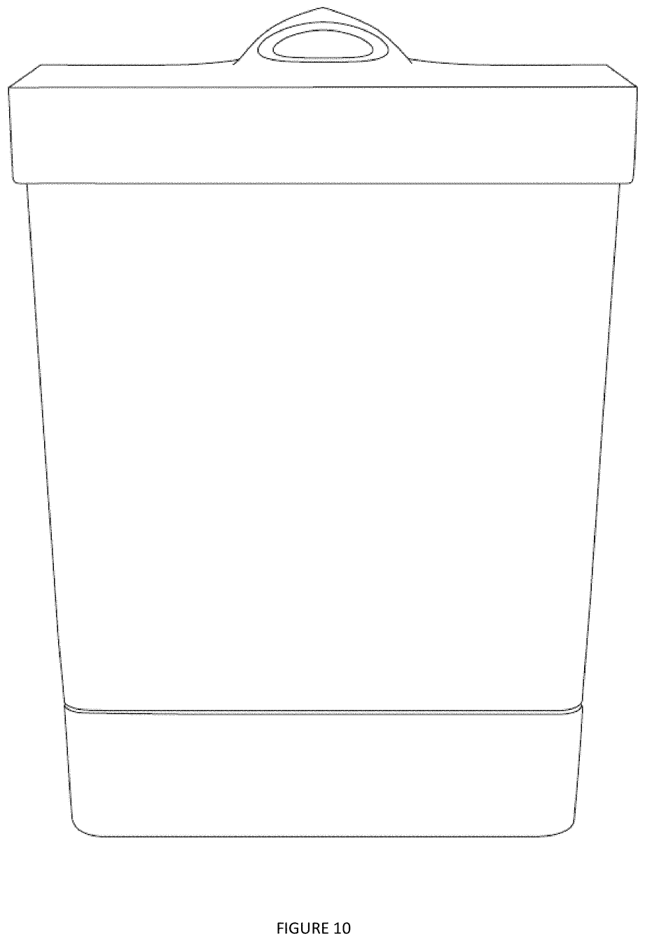

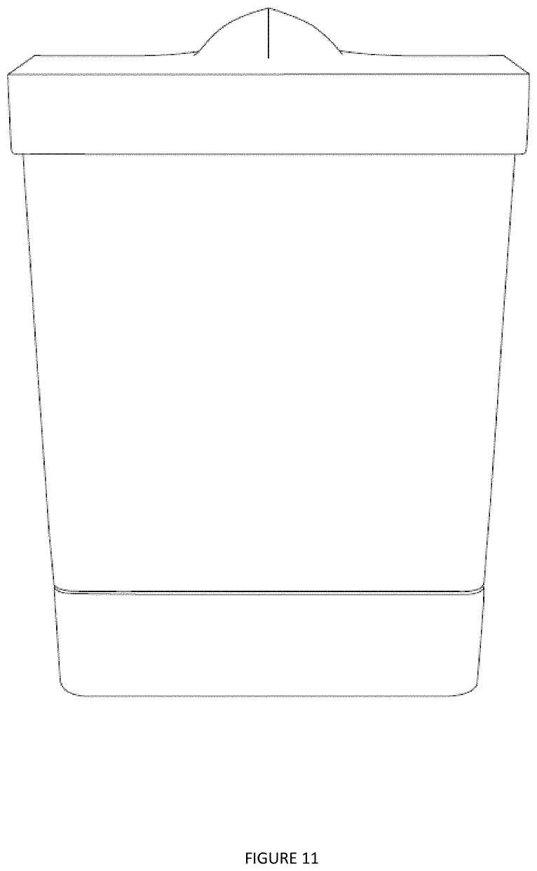

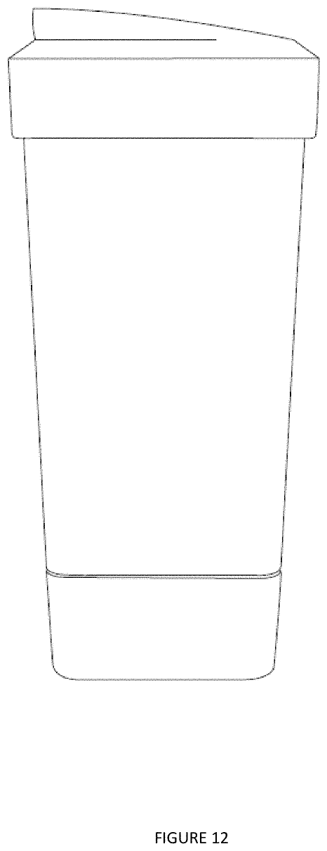

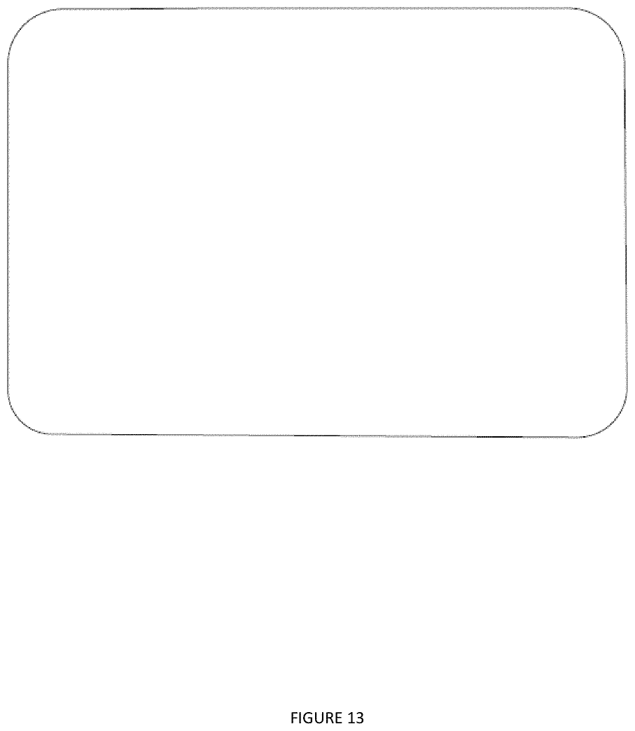

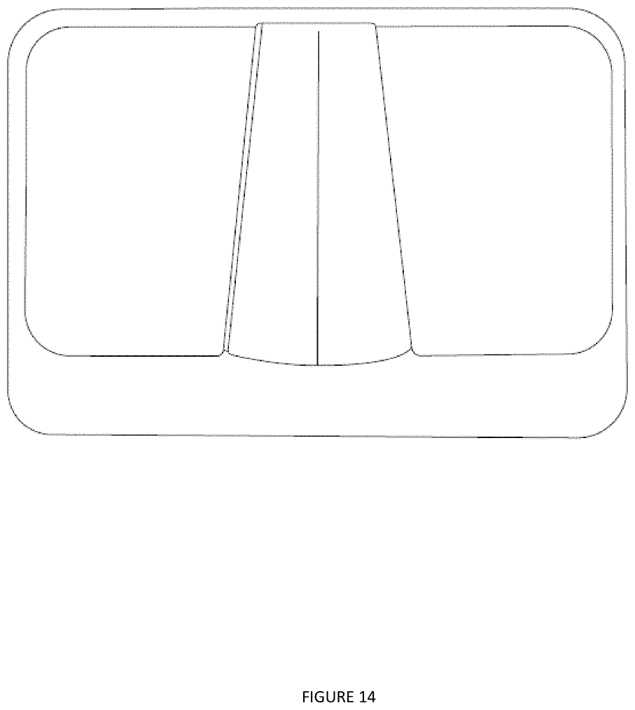

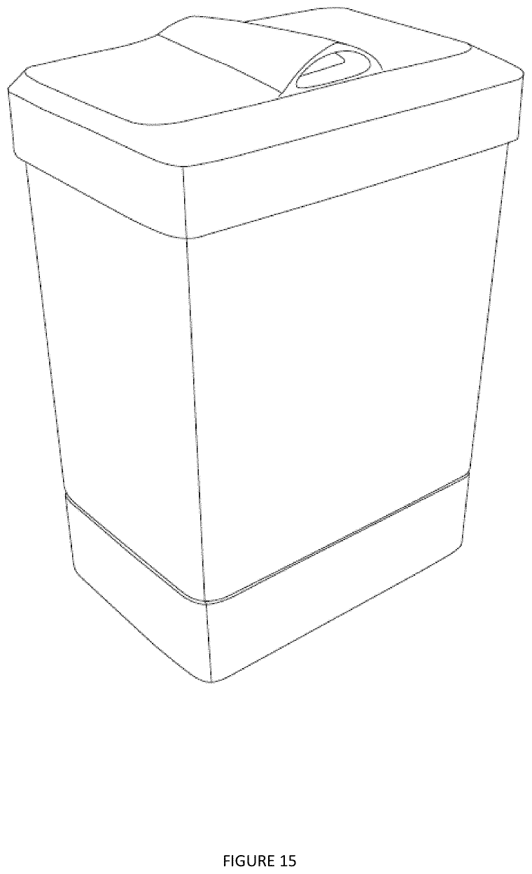

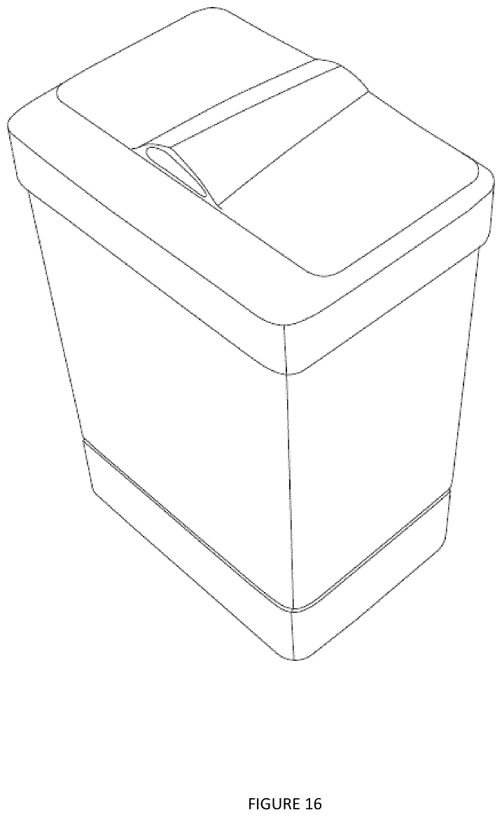

FIGS. 9-16 depict various views of a storage container, according to an embodiment.

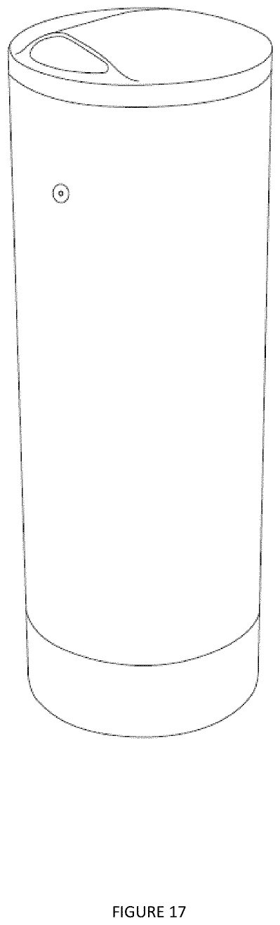

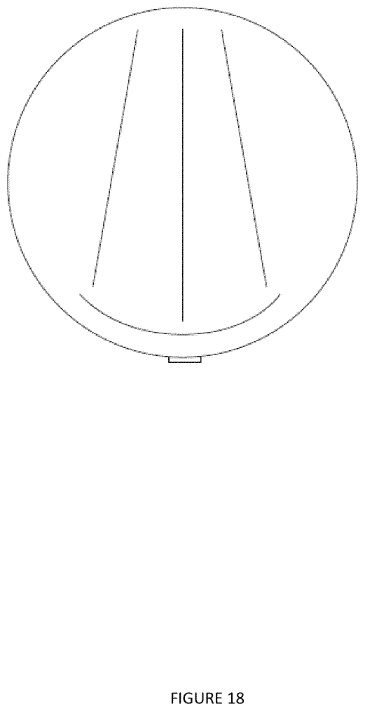

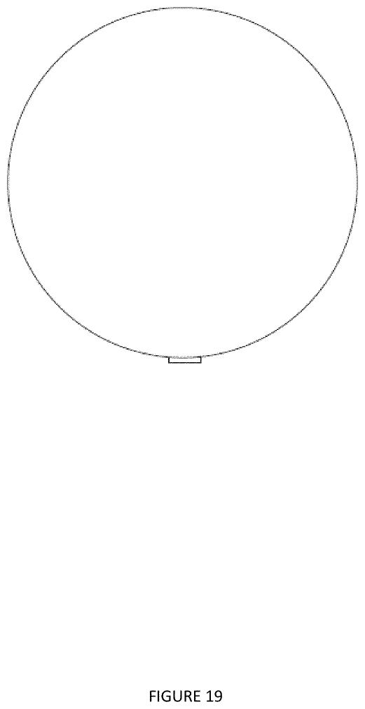

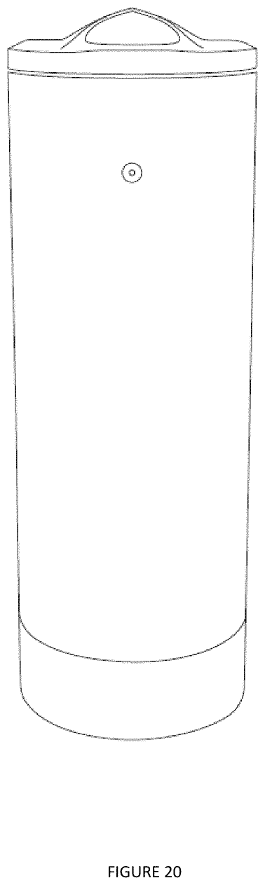

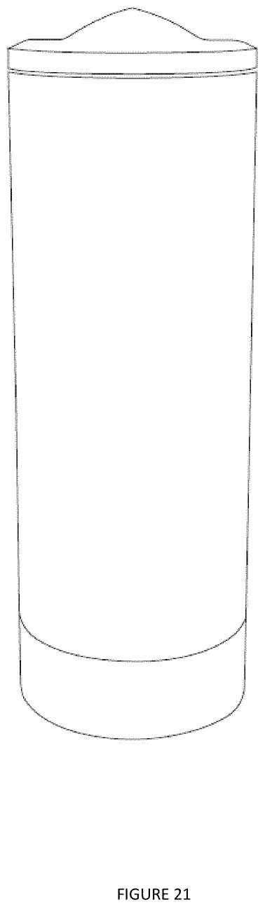

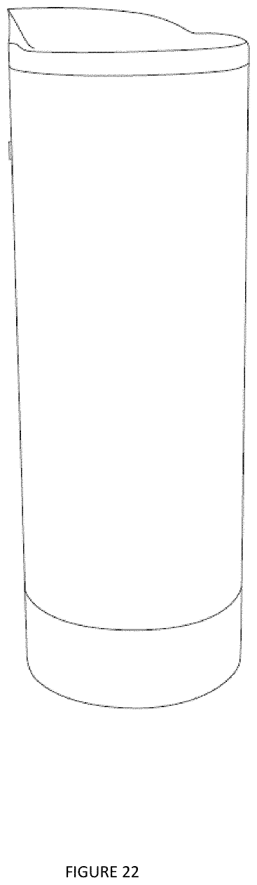

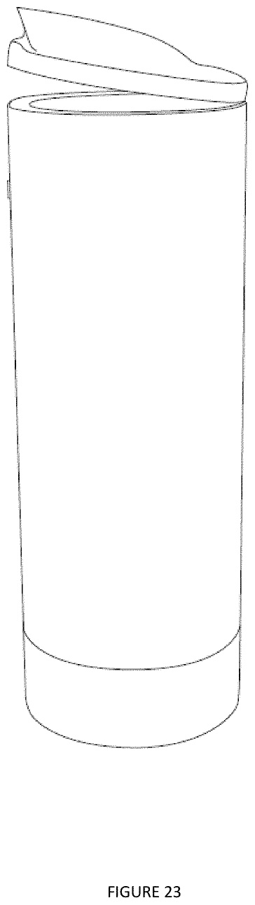

FIG. 17-23 depict various views of a storage container, according to an embodiment.

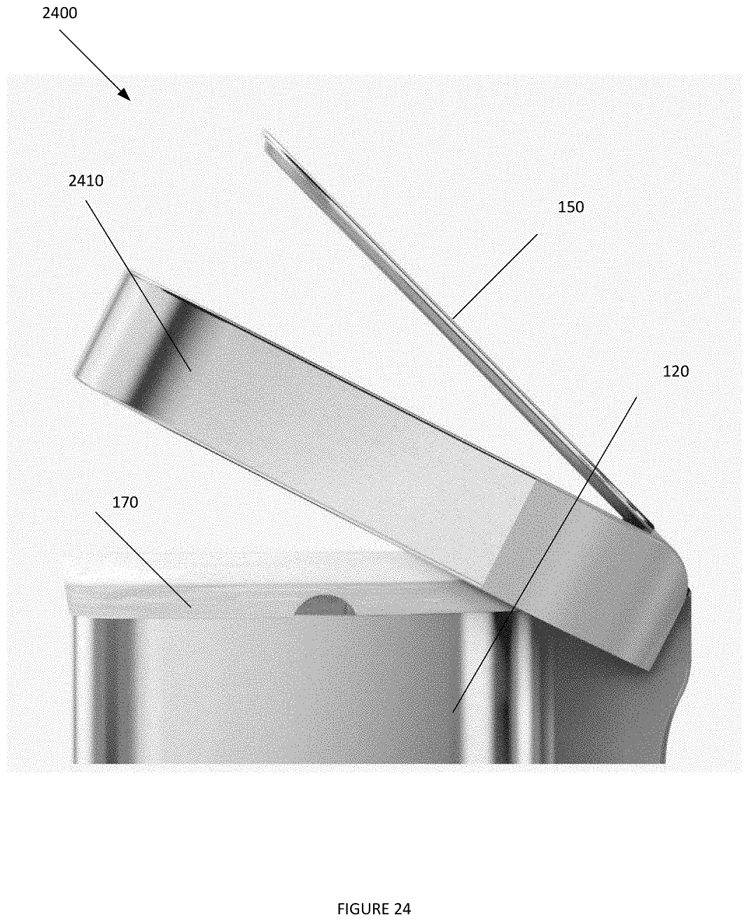

FIG. 24 depicts a storage container, according to an embodiment. Elements depicted in FIG. 24 may be described above, and for the sake of brevity a further description of these elements is omitted.

As depicted in FIG. 24 storage container 2400 may include a lid 150 with a locking mechanism 2410. Locking mechanism 2410 may be configured to encompass an upper edge of bag 170, wherein bag 170 is configured to be positioned and cover a rim of insulating layer 130. More specifically, locking mechanism 2410 may be configured to be positioned over the rim of shell 120 that is covered by bag 170, and along the outer circumference of shell 120 and bag 170. When in a closed positioned locking mechanism 2410 may apply a compressive force against the rim of shell 120 and bag 170 to secure bag 170 in place.

Furthermore, when in a closed positioned, lid 150 may be configured to be opened and closed to expose an inner circumference of bag 170 while bag 170 is secured in place. This may allow a seal to be created between the outer and inner insulating layers 130, 140 that is created by locking mechanism 2410 to limit the amount of cooled air that can exit the chamber even when lid 170 is opened and closed.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A climate controlled storage container comprising:
an exterior shell;
an interior shell having a closed bottom end and an open upper end, and sidewalls extending from a circumference of the open upper end to the closed bottom end;
an insulating layer positioned between the exterior shell and the interior shell, the insulating layer having a larger thickness than the exterior shell and the interior shell;
a first fan positioned within a lower end of the insulating layer shell; and
a bag with a proximal end that is configured to be secured in place between the open upper end of the interior shell and the insulating layer, wherein portions of the bag are configured to contact the sidewalls of the interior shell to transfer heat through conduction from interior shell to the bag.

2. The climate controlled storage container of claim 1, further comprising:
a lid configured to cover and uncover the open upper end of the interior shell;
a first temperature plate positioned within the lid, the first temperature plate configured to vary a temperature within a hollow body associated with the interior shell.

3. The climate controlled storage container of claim 2, wherein the first temperature plate is positioned on an opposite end of the climate controlled storage container than the first fan.

4. The climate controlled storage container of claim 2, further comprising:
a second temperature plate positioned within the closed bottom end of the interior shell.

5. The climate controlled storage container of claim 4, wherein the first temperature plate and the second temperature plate are independently controlled on independent cycles.

6. The climate controlled storage container of claim 2, wherein the interior shell includes first vents and the exterior shell includes second vents, wherein the first fan is configured to vacuum air from inside a hollow chamber within the interior shell to an area external to the external shell.

7. The climate control storage container of claim 6, wherein the lid includes a second fan.

8. The climate control storage container of claim 2, wherein the lid includes a seal.

9. The climate control storage container of claim 1, wherein the bag is configured to contact the sidewalls of the interior chamber from the open upper end to the closed lower end.

10. The climate control storage container of claim 1, wherein the lid is configured to contact a rim of the external shell when the lid is in a closed position.

11. A method utilizing a climate controlled storage container comprising:
positioning an internal shell within an insulating layer, the interior shell having a closed bottom end and an open upper end, and sidewalls extending from a circumference of the open upper end to the closed bottom end, the insulating layer having a larger thickness than the exterior shell and the interior shell;
positioning the insulating layer and the interior shell within an exterior shell;
controlling a first fan positioned within a lower end of the insulating layer shell; and
securing a proximal end of a bag in place between the open upper end of the interior shell and the insulating layer, wherein portions of the bag are configured to contact the sidewalls of the interior shell to transfer heat through conduction from interior shell to the bag.

12. The method of claim 11, further comprising:
Uncovering and covering the open upper end of the interior shell via a lid;
controlling a temperature within a hollow body associated with the interior shell via a first temperature plate positioned within the lid.

13. The method of claim 12, wherein the first temperature plate is positioned on an opposite end of the climate controlled storage container than the first fan.

14. The method of claim 12, further comprising:
controlling a second temperature plate positioned within the closed bottom end of the interior shell.

15. The method of claim 14, wherein the first temperature plate and the second temperature plate are independently controlled on independent cycles.

16. The method of claim 12, wherein the interior shell includes first vents and the exterior shell includes second vents, and
vacuuming air, via the first fan, from inside a hollow chamber within the interior shell to an area external to the external shell.

17. The method of claim 16, wherein the lid includes a second fan.

18. The method of claim 12, wherein the lid includes a seal.

19. The method of claim 11, further comprising:
contacting the sidewalls of the interior chamber by the bag from the open upper end to the closed lower end.

20. The method of claim 11, further comprising:
contacting the lid with a rim of the external shell when the lid is in a closed position.
